(19) United States
(12) Patent Application Publication
(10) Pub. No.: US 2013/0206172 A1
(43) Pub. Date: Aug. 15, 2013

(54) OIL REMOVAL METHOD AND APPARATUS

(71) Applicants: Mia Bjar, Krakeroy (NO); Arne Skeie, Norheimsund (NO); Marius Hover Montarou, Heggedal (NO); Silje Rabben, Bekkjarvik (NO)

(72) Inventors: Mia Bjar, Krakeroy (NO); Arne Skeie, Norheimsund (NO); Marius Hover Montarou, Heggedal (NO); Silje Rabben, Bekkjarvik (NO)

(73) Assignee: KALIBER INDUSTRIDESIGN AS, Trondheim (NO)

(21) Appl. No.: 13/805,353

(22) PCT Filed: Jun. 21, 2011
(86) PCT No.: PCT/GB11/51164

§ 371 Date: Feb. 18, 2013

(30) Foreign Application Priority Data
Jun. 25, 2010 (GB) 1010810.8
Jun. 25, 2010 (US) 61358479

(51) Int. Cl. B08B 7/04

(52) U.S. Cl. CPC B08B 7/04
USPC 134/6; 15/320

(57) ABSTRACT

A device for removing spilled oil, oily substances or other liquids from a surface has a main body with a pair of handles towards its upper end and a cleaning head at the lower end. The cleaning head is fitted with rotary brushes and also contains a motor and drive gear. At the upper end of the main body, a flexible pipe is connected to a hollow passage formed by and extending through the main body via a short flexible pipe to the cleaning head. In the opposite direction, the flexible pipe extends to remote air pressure, vacuum and sorbent material sources. The device has three main modes of operation which are used in sequence to supply absorbent material (e.g., chipped bark) to the contaminated ground; then the absorbent material is massaged into the surface of the ground; and finally the absorbent material together with the liquid is removed.

The present invention relates to an apparatus and method for cleaning surfaces which have been polluted with liquids and, in particular, oily substances, such as petroleum.

Petroleum (crude oil) is a vital commodity for the modern economy. Vast quantities are extracted from underground reservoirs and shipped all over the world. Although this is usually done safely, unfortunately, spillages do occur either as a direct result of exploration and production, e.g. when a well blows out, or during transportation if a tanker or pipeline is damaged. Oil spillages can be particularly serious when they happen at sea; the oil may be transported significant distances by water currents, wind and tides before washing up on shore, potentially polluting miles of coastline and providing a hazard to wildlife and ecosystems.

When this occurs it is desirable to remove the oil in order to restore the shoreline or other ground. Suction pipes may be used to remove pools of oil, but it is conventional to clean hard surfaces such as rocks, concrete or the like manually by first spreading a sorbent on the surface before a number of people with shovels and brushes manually massage the sorbent into the oil before it is scraped off and dumped into containers for disposal. Any remaining oil will, eventually, be broken down by natural biological processes.

This is difficult and hazardous work. Furthermore, it necessitates many people and the availability of equipment and the like nearby. This is very seldom the case, and many oil spills occur in inconvenient places.

Efforts have been made to address these problems. For example, Fl 112967 discloses an oil cleaning unit with a suction pipe having a mouth piece and a rotating brush. U.S. Pat. No. 4,251,362 discloses the use of a binder material being mixed with the oil. WO 00/61874, WO 93/20287 and WO 99/22077 show different kinds of vacuum machines, mainly for use in removing spilt oil from the beach zone. U.S. Pat. No. 449,200 discloses an apparatus for cleaning up an oil spill in which sorbent material is blown out of a duct by an air current so that it can sorb oil on the ground before being sucked back into the device.

According to the present invention there is provided apparatus for removing an oily substance from a surface comprising means for conveying sorbent material to the surface entrained in a gas, means for mechanically massaging the sorbent material into the oily substance and suction means for removing the sorbent material.

Thus, by means of the present invention sorbent material may be effectively combined with the oily substance that it is intended to recover in a highly convenient manner. This results in far more effective recovery than simply blowing the sorbent onto the oily ground. When the massaging means act upon the sorbent and oily substance mixture they effectively mix oil and sorbent together. This mixing action is the limiting factor for prior art oil cleaning operations and is the one that takes most time. Mechanical mixing as provided by the invention is thus highly advantageous compared to manual mixing.

The invention therefore provides a convenient and advantageous apparatus for cleaning up petroleum spillages. However, it is useful for removing spillages of other oils and oily substances, including food oils, e.g. fish oils, olive oils, etc. In the following discussion, references to “oil” include any such substance.

The sorbent material may be supplied from a sorbent source and combined with the gas, typically air, from a compressor or the like. A venturi mixer is a convenient means for combining the sorbent and air; the sorbent may be supplied to a hopper and then gravity-fed into the mixer.

Preferably the apparatus of the present invention comprises a unit with a nozzle for supplying the entrained sorbent material to the massaging means. The massaging means may act to spread the sorbent prior to massaging it into the oil. The suction means is preferably connected to the same nozzle as the sorbent supply and this is preferably located at the centre of the massaging means.

The massaging means preferably comprises a plurality of mechanically rotating massaging members, such as brushes or other arrays of bristles. The length, thickness and material of the bristles may be selected according to conditions of use. However, other systems may be used, such as flexible paddles or squeegees. Preferably the nozzle and massaging components are all located within a single mechanical unit which may be designed for hand-held operation or may be built on a larger scale for attachment to a vehicle or vessel.

Although the massaging and air systems can be entirely independent of each other, it is preferred that the massaging means be used to distribute the sorbent as it is supplied and/or to assist in recovering the sorbent. Preferably, the latter step is facilitated by reversing the direction of rotation of the massaging means.

The invention extends to a corresponding method, thus, viewed from a second aspect the invention provides a method of removing oil from a surface comprising conveying sorbent material to the surface entrained in a gas, mechanically massaging the sorbent material into the oil and removing the sorbent material, wherein the steps of the method are all performed using a single device.

The sorbent, which may have absorbent and/or adsorbent properties, may be any suitable sorbent, but bark is preferred as this is a known material for sorbing oil and is readily available. Suitable products are sold under the trade marks Zygol, Reba, Kallak are all barks. Other materials may be used when bark is unavailable or less convenient. The main property of the sorbent is that it should be blowable without too much effort, and that it should not be too light. Moss, lichen, peat, lime, pumice, products based on plant fibres, and polypropylene or polyethylene pellets are other options.

The sorbent should most preferably be a solid or semi-solid, but it should be entrained in a gas, not a liquid. In particular, water is not useful for carrying the sorbent. Pumping water may result in the spill propagating and also in that polluting water may spread into the environment. In contrast, the invention provides a dry process in which there is no propagation of the spill.

In a simple embodiment, the massaging means are elongate and arranged on a rotatable disc along lines extending from the periphery to the centre. Thus, there may be a plurality of sets of radially extending bristles. This arrangement is not optimal, however. In order to provide a more controlled manner of supplying the sorbent, the inventors have discovered that by curving the elongate massaging members (at least when the massaging members are rotating) much as in a turbine, the sorbent can be supplied more effectively. Thus, whilst elongate massaging members still extend along lines towards the circumference of the disc, those lines are curved in use, such that they are convex when viewed from outside the disc. The lines may, for example, form similar arcs of a circle. They need not, and typically will not, pass through the centre of the disc.

A further advantage of curved elongate massaging members is that when the rotation is reversed in order to collect the oily sorbent, the curved shape will tend to more efficiently scoop up the sorbent and convey it towards the centre of the disc from where it may conveniently be extracted by suction.

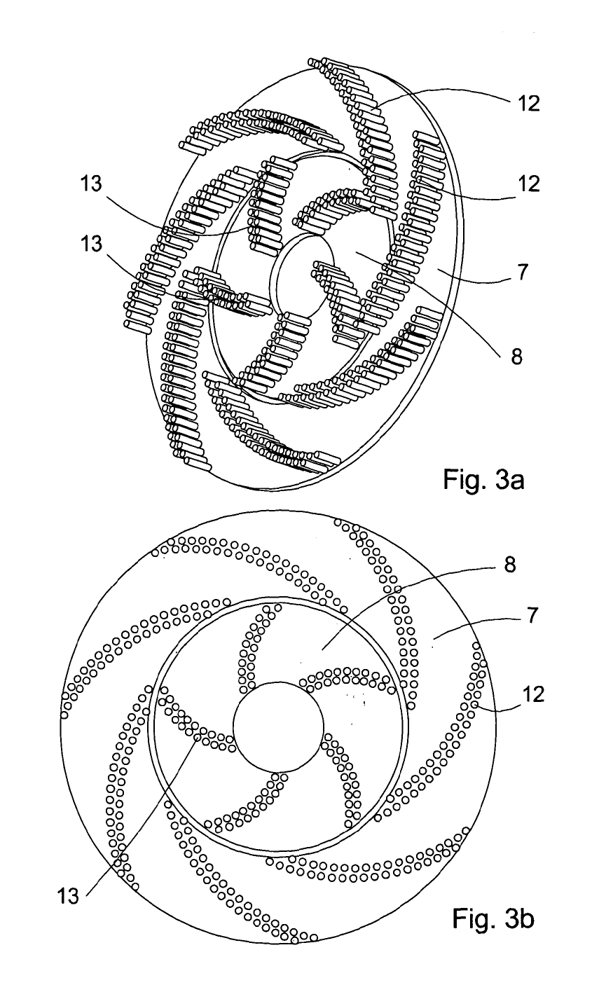

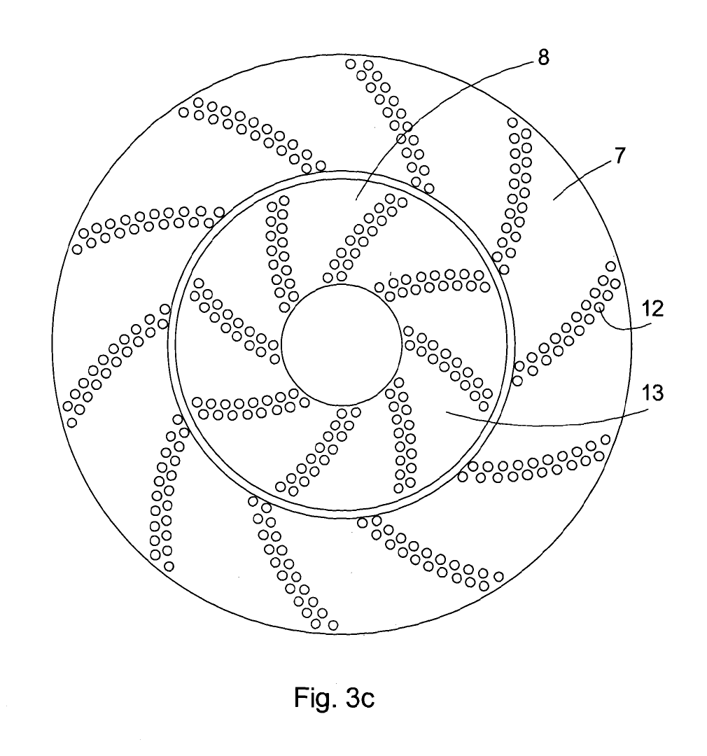

A more preferred system comprises a pair of co-axial rotatable discs, each having a set of massaging members such that there are inner and outer arrays of preferably curved elongate massaging members, which may be as described above, for example as shown in FIG. 3a. This provides a highly effective way of spreading of the bark and then later recovering the same.

Most preferably, the rotatable discs are arranged to contra-rotate. As well as providing an improved spreading, kneading and massaging action, this arrangement allows the torque reactions of the two discs to substantially cancel each other out, which makes the device much easier for the operator to control; if there were only one, the machine would tend to pull in one direction.

Where the discs contra-rotate, the massaging means are preferably configured to nevertheless drive sorbent in the same direction (either inwardly or outwardly), i.e. the massaging means may curve in opposite directions—if one array curves outwardly clockwise, then the other would curve outwardly anti-clockwise.

It will also be appreciated that more than two discs of brushes may be provided, though this does increase the complexity of the apparatus.

The massaging members may have a suspension system such that they follow the surface in a better manner. Preferably each member has independent suspension.

In some embodiments, it may be desirable to limit the radial distribution of sorbent beyond the apparatus to limit the extent to which it is ejected radially. In this case, a preferably flexible skirt may be provided around the base of the device. For example, there may be fabric, such as oil cloth, or flexible polymer sheet arranged around the outer circumference of the spreader to prevent the bark from being blown away.

As discussed above, the elongate massaging members are preferably curved in use, i.e. when the rotatable discs are turning. However, as it can be inconvenient to bend continuous lines of, for example, bristles, in order to provide curved massaging members, it is possible to employ normally-straight massaging members that curve in use. It is also possible to use a plurality of discrete straight elongate components arranged in line to approximate to a continuous curved elongate massaging member.

The massaging members are preferably removable to allow for replacement due to wear-and-tear. The massaging members, or components thereof, are therefore preferably formed as replaceable inserts. Using, for example, bristle inserts like this also allows the bristles to be changed after wear, and where appropriate, only the worn-out inserts need be replaced.

Where brushes with bristles are used, they may be formed of any suitable material, but must be resistant to oil. Depending on the nature of the oil that has been spilled, the bristles may be chosen for their softness or hardness as appropriate. The bristles must be sufficiently stiff to scrub the surface effectively.

The sorbent may be massaged and kneaded into the oil for some time to ensure that it picks up the maximum amount of oil. It is possible to continually supply sorbent, but it will generally be more economical and effective to cease the flow of sorbent while massaging continues. After having kneaded the sorbent and oil it may be left for some time for the bark to act upon the oil. This period is variable and may not be necessary at all, depending on the spill and the material onto which the spill has occurred.

As discussed above, after necessary kneading (and possibly waiting), the material may now be suctioned up through the pipe. In order to supply the necessary suction a compressor is preferably used. At least in the case of a hand-operated device, this is preferably remotely located and connected to the apparatus by a flexible pipe or hose. Any such pipe or hose should be stiff enough to resist the suction vacuum. For a typical example, a 1 bar blowing power and ½ bar suction compressor is suitable. A further advantage of using a system like this is that electricity outlets are usually provided at the compressor. Thus electricity may be provided by the compressor to the apparatus in order to power it. However, the apparatus may be battery driven, driven by means of a gasoline engine, etc.

A sorbent supply container is preferably provided. This is simply a container from which sorbent is suctioned to be put onto the surface. A venturi injector is a convenient way to mix the sorbent with the gas. When a remote compressor is used, the container will typically be located between the compressor and the apparatus.

In addition, there is preferably provided a cyclone separator for separating oily sorbent from the air in which it is entrained during the sorbent recovery stage. This is also preferably connected to the other components by flexible pipe or hose.

Alternatively, a fully-integrated apparatus may be provided. For example, an apparatus for single person-use may be provided in the form of backpack with two compartments and an engine, with one compartment for fresh sorbent and the other for oily sorbent. The device itself should be lightweight and resistant to oil. It may have wheels, or be mounted on a car or a boat.

The apparatus preferably comprises a head which carries the rotatable discs on which the massaging members are mounted, the head being movable relative to the body of the apparatus; preferably it has freedom in movement in all directions.

A variant of the apparatus described above is suitable for use on sandy surfaces, such as sandy beaches. Here, the bristles may be replaced by lamellae which work as “paddle wheels” shovelling the oil containing sand towards the nozzle such that the sand is suctioned away. It will be appreciated that in this arrangement the supply of sorbent may be dispensed with. Thus, viewed from another aspect the present invention provides apparatus for removing oil from a surface comprising means for mechanically massaging sorbent material into the oil and suction means for removing the sorbent material.

One design option is to have the air itself drive the massaging members. In this way only air is used for driving the device and a separate electricity supply to the apparatus is not needed.

Although the invention has been discussed in the context of large-scale oil spills, it is equally applicable to much smaller scale spillages such as those that occur at garages, airports, race tracks, ports, docks, harbours or the like. Furthermore, as discussed above, the invention is not limited to the removal of petroleum and petroleum-based oils. For example, the invention may also be used to remove fish oils, olive oils, etc. and also other oily substances such as paint, as well as other types of liquid (see below). One potential use would be after accidents. A second potential field could be in shops or the like in which it is crucial to clean the floor after say a bottle of oil has been spilt. Hence, the invention may be useful to clean any hard surface on which an oily substance may be spilled.

Viewed from another aspect, the invention provides an apparatus for removing oil from a surface, the apparatus comprising a body that may be held by a user of the apparatus, rotatable massaging members mounted to a lower part of the apparatus, and a sorbent conduit terminating adjacent to the massaging members.

Preferably the massaging members are located on one (or a plurality of co-axial) rotating members, the conduit preferably being arranged co-axially therewith. Most preferably, the massaging members comprise a plurality of curved brushes depending from a pair of contra-rotating discs, with the conduit preferably terminating at an opening in the centre of the inner disc.

The apparatus of this aspect of the invention preferably comprises the preferred features of the other aspects of the invention as set out above. The conduit is preferably connected to a supply of sorbent entrained in air and/or to a vacuum source for recovering sorbent. The connection is preferably selectable by the user by means of a control on the apparatus.

Although the invention was developed to address the problem of cleaning up spillages of oil and oily substances (particularly petroleum), it has been found to be equally effective for removing spillages of other liquids. Generally it requires no modification, although different sorbents may be used with it and it may also be desirable to add a detergent to the sorbent or otherwise supply it. Also, if it is used to clean up corrosive materials, it may be necessary to use suitably corrosion-resistant materials in its construction.

Thus, according to a further aspect of the invention there is provided a method of removing a liquid from a surface comprising conveying sorbent material to the surface entrained in a gas, mechanically massaging the sorbent material into the liquid and removing the sorbent material, wherein the steps of the method are all performed using a single device.

The liquid may be oil or an oily substance, as discussed previously, or any other liquid, which may require cleaning up after a spillage such as industrial chemicals, paints, glycols, etc.

The sorbent is preferably selected based on the liquid in question, but the apparatus used is preferably as previously described.

It is also envisaged that the apparatus may be useful for the purpose of massaging and/or kneading sorbent that is supplied by, and possibly also collected by, other means. Thus, a further aspect of the invention relates to an apparatus for use in oil recovery comprising massaging means, which are preferably rotating massaging members and most preferably are as set out above.

An embodiment of the invention will now be described, by way of example only, and with reference to the accompanying drawings:

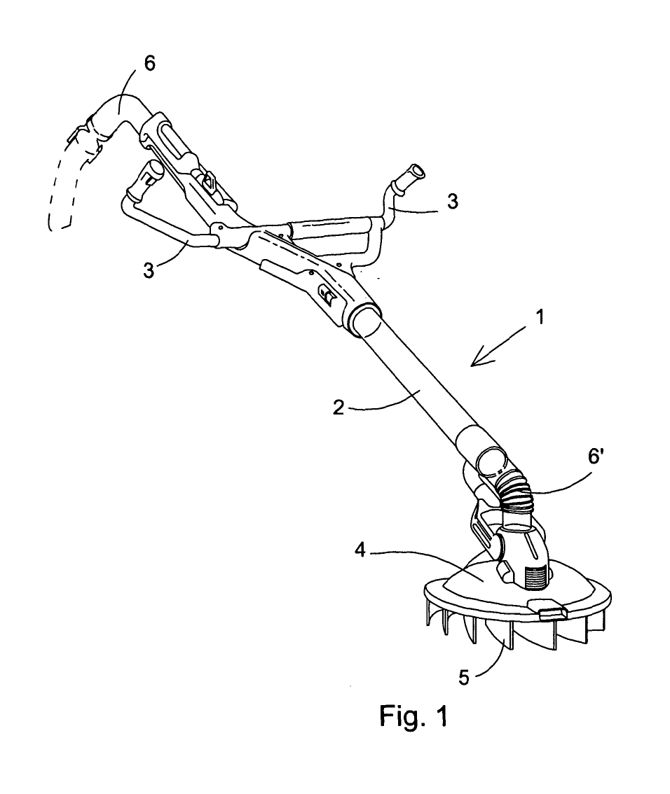

FIG. 1 shows a perspective view of an oil removal device according to the invention;

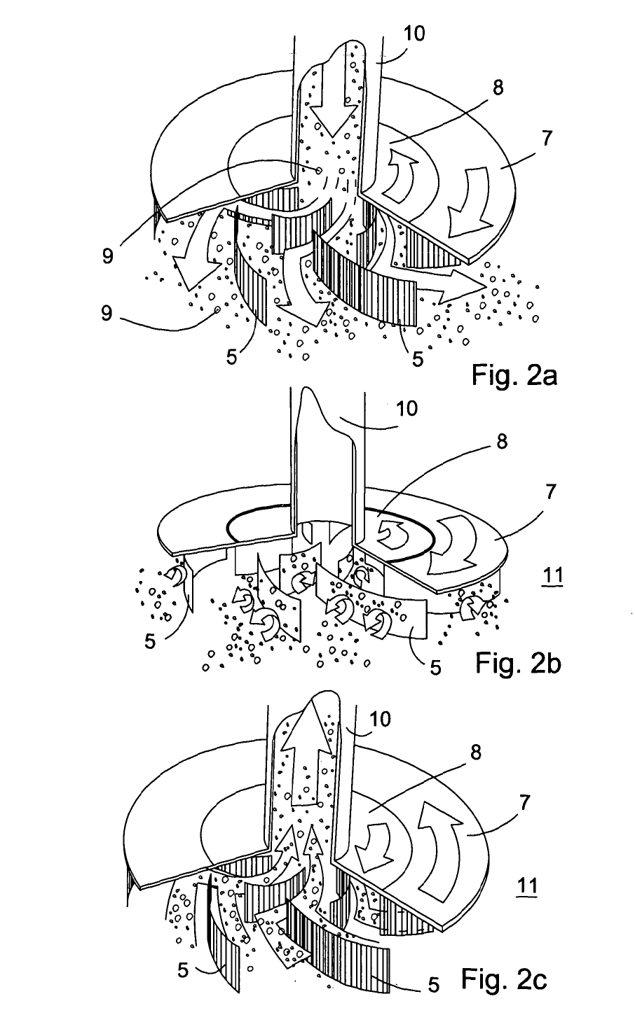

FIGS. 2a-c are a series of partially cut-away perspective views of the lower end of the device of FIG. 1 showing three stages in the operation of the device;

FIG. 3a shows a perspective view showing a version of the arrays of brushes;

FIGS. 3b and 3c are plan views of two alternative arrays of brushes;

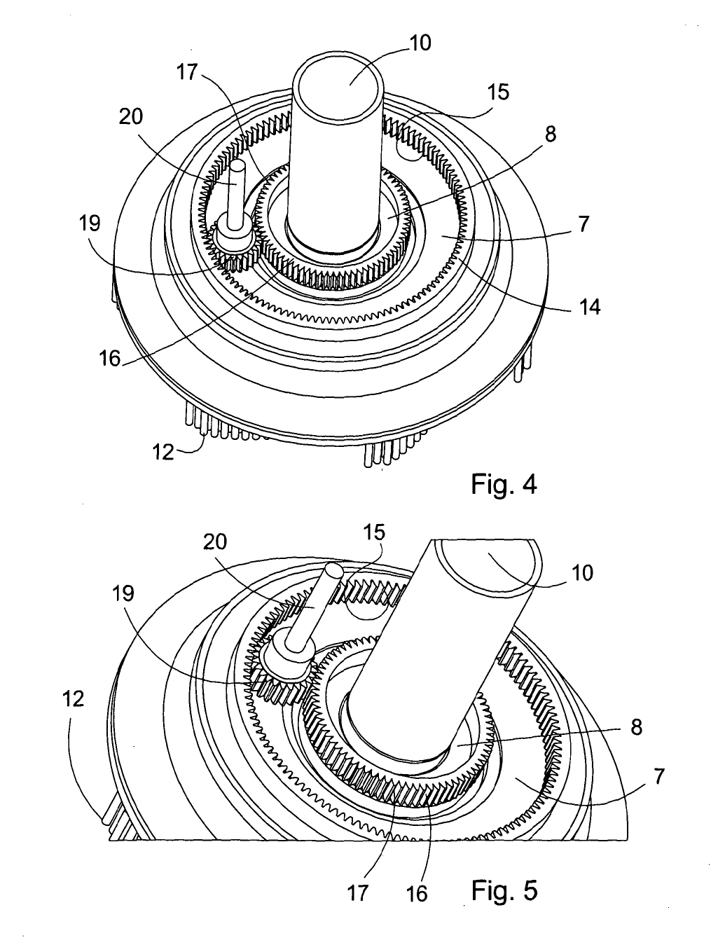

FIG. 4 is a perspective view from above of the interior of the lower part of the device showing the drive mechanism;

FIG. 5 is an enlarged view of part of FIG. 4 showing part of the drive mechanism in more detail;

FIG. 6 is a partially cut-away perspective view of the mechanism of FIGS. 4 and 5;

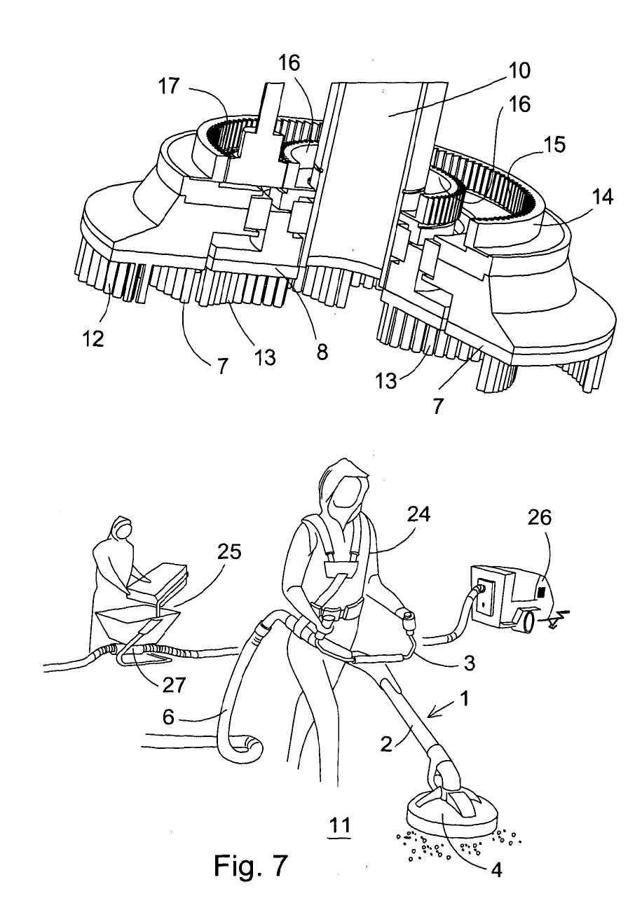

FIG. 7 illustrates the device in operation connected to ancillary devices;

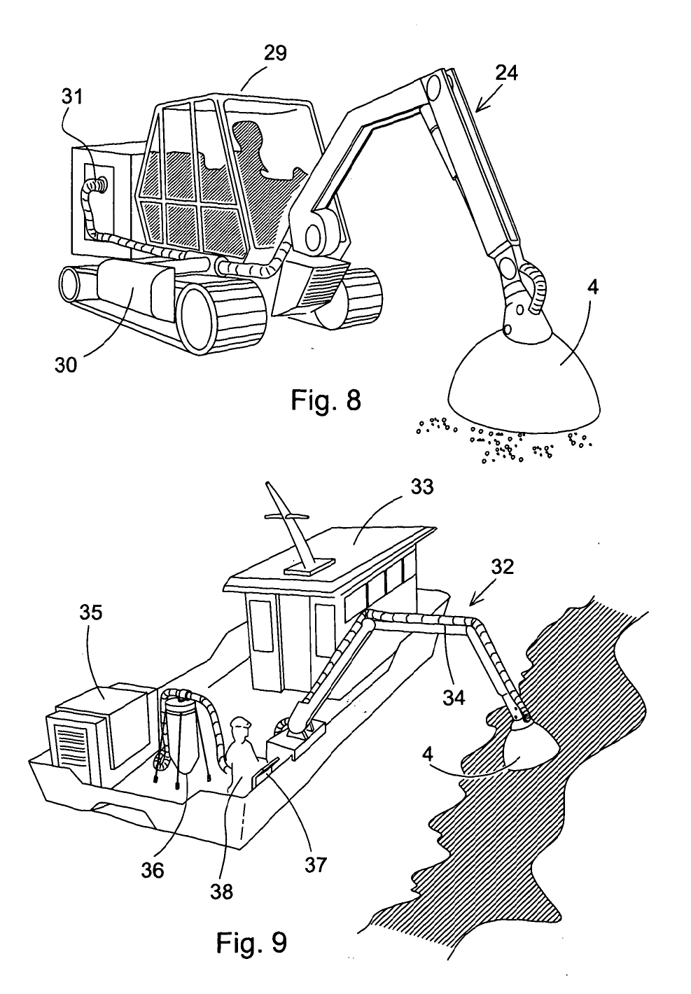

FIG. 8 shows an embodiment of the invention configured for attachment to earthmoving equipment; and

FIG. 9 shows an embodiment of the invention configured for attachment to a vessel.

FIG. 1 shows an oil removal device 1 according to an embodiment of the invention. It has a main body 2 with a pair of handles 3 towards its upper end and a cleaning head 4 at the lower end. The cleaning head is fitted with rotary brushes 5 and also contains a motor and drive gear (not shown in this figure but discussed below). At the upper end of the main body 2 a flexible pipe 6 may be seen. This is connected to a hollow passage formed by and extending through the main body 2 via a short flexible pipe 6′ to the cleaning head 4. In the opposite direction the flexible pipe 6 extends to remote air pressure, vacuum and sorbent material sources.

The oil removal device 1 has three main modes of operation which are used in sequence to clean up spilled oil. It is used to supply absorbent material (typically chipped bark) to the oil-covered ground; then the absorbent material is massaged into the surface of the ground; and finally the absorbent material together with oil is removed. These stages are illustrated in FIGS. 2a-c.

FIGS. 2a-c show some of the internal components of cleaning head 4. The brushes 5 are attached in two circular arrays to a pair of concentric drive-discs 7, 8 which are caused to contra-rotate as shown by the arrows. As shown in FIG. 2a, chipped bark 9 is first supplied to the brushes by entraining it in compressed air which is supplied via pipe 10, which is connected via short flexible pipe 6′, the body 2 and flexible pipe 6 to the sources of air and absorbent material. The chipped bark is supplied to the centre of the concentric brush arrays and is then spread over the surface of the ground, as shown by arrows, by the action of the brushes.

The next stage is shown in FIG. 2b. After sufficient chipped bark has been supplied to the surface, the flow of air (and entrained bark) is stopped. The rotating brushes 5 are then used to massage and knead the chipped bark 9 over the oil-covered ground 11 so that the chipped bark absorbs and becomes covered with oil. The bark may also intermittently be pumped onto the surface, whilst massaging and kneading.

When it is judged that the chipped bark has become saturated with oil the third stage is commenced. As shown in FIG. 2c, suction is then applied to pipe 10 (by means of a vacuum source via flexible pipe 6). This causes the oil-covered chipped bark 9 to be sucked up the pipe 10 as shown by the arrows in the manner of a vacuum cleaner.

The user changes the mode of operation of the device 1 by means of a control lever mounted to a control unit on the main body 2 (not shown in FIG. 1). This is connected by means of a control signal cable (not shown) attached to the flexible pipe to the sources of air, suction and absorbent material so that chipped bark entrained in air can be supplied or suction applied as desired.

FIGS. 3a and 3b illustrate the two circular arrays of brushes 5. The outer array 12 is mounted to the outer drive disc 7 and the inner array 13 is mounted to the inner drive disc 8. The brushes may be mounted using brackets (not shown) at right-angles to the drive disks.

Note that the brushes are all curved with the inner array of brushes 13 being arranged outwardly clockwise (i.e. they extend outwardly when followed in a clockwise directly) and the outer array 12 being arranged outwardly anticlockwise. FIG. 3c differs from 3a and 3b in that is shows a variant with a larger number of brushes.

Each of the concentric rings may be independently suspended and damped.

FIGS. 4-6 show the brushes and drive discs of FIGS. 3a-c together with their drive mechanism. It may be seen that upstanding outer collar 14 is fixedly located on the upper surface of outer drive disc 7 and likewise inner collar 16 is provided on inner drive disc 8. Both collars extend concentrically around pipe 10. Rings of teeth 15, 17 are provided on the inside surface of outer collar 14 and the outside surface of inner collar 16 respectively.

Located between the two collars is a drive sprocket 19 mounted on drive shaft 20. The drive sprocket 19 engages with both rings of teeth 15, 17 such that rotation of the drive shaft causes the drive sprocket to turn the collars 14, 16 in opposite directions.

A drive motor (not shown) is mounted to the head of the device and is connected directly to drive shaft 20. Electrical power is supplied to the drive motor by means of an electrical cable 23 which runs along the flexible pipe 6 to a remote power supply.

FIG. 5 shows in more detail the engagement between the drive sprocket 19 and the rings of teeth 15, 17. FIG. 6 illustrates the relationship between the drive mechanism and brushes on the one hand and the pipe 10 on the other. It will be noted that the pipe is co-axial with both drive discs 7, 8 so that in use sorbent is delivered into the centre of the rotating brushes.

Operation of the device 1 is shown in FIG. 7. An operative 24 is shown holding the device by means of handles 3 as he cleans oil-covered ground 11. Flexible pipe 6 extends from the device to bark supplier and separator 25 and compressor 26.

The compressor 26 also comprises an electrical generator and supplies the power for drive motor 21 via a power cable which runs along flexible pipe 6.

When the device is to be operated to perform the first stage of the cleaning process (as shown in FIG. 2a), the operative sets the control lever so that a control signal is sent from the control unit to the compressor and bark supplier and separator. This causes the compressor to supply compressed air to the flexible pipe 6 and for the bark supplier/separator to supply chipped bark to the air pipe by means of a venturi mixer 27. The chipped bark is entrained in the air and supplied to pipe 10 as discussed above.

Moving the control lever to a second position sends control signals which terminate the supply of chipped bark and air so that the second stage (FIG. 2b) may commence. When the chipped bark has been sufficiently massaged into the oil the lever is moved to a third position leading to the commencement of the third stage (FIG. 2c). This causes the compressor 26 to switch into suction mode to suck up the oily bark, and for the bark supplier and separator 25 to switch to separator mode. In this mode the air and its entrained oily bark is passed through a cyclonic separator in order to remove the oily bark from the air.

As mentioned above, in this embodiment, the drive motor is mounted to the head of the device 1. However, in an alternative embodiment the drive motor is mounted higher up the device, for example at an upper end of the main body 2. This can provide a weight distribution which is easier for a user to handle. Power is transferred down to the head 4 from the drive motor via a flexible wire. The flexible wire can allow the head 4 to move freely in three dimensions.

FIG. 8 shows a second embodiment 28 of the invention which is functionally identical to the first embodiment, but which is of significantly larger scale and is adapted for use with an earth mover 29 where it is mounted in place of the conventional bucket. It will be noted that the earth mover 29 is modified to carry a tank 30 for oily bark and an air pump/vacuum system 31 (corresponding to the compressor 26).

FIG. 9 shows a third embodiment 32 of the invention which is adapted for use on a vessel 33. This enables access to areas of shoreline which cannot easily be reached by land. The cleaning head of the embodiment 32 is mounted at the distal end of an articulated arm 34 so that it can be operated from the vessel in a similar way to that in which the previous embodiment is operated from the earth mover. A control panel 37 is provided for use by the operator 38. Like the previous embodiment, an air pump/vacuum system 35 and tank for oily bark 36 are provided on board the vessel.

We claim:

1. Apparatus for removing an oily substance from a surface comprising means for conveying sorbent material to the surface entrained in a gas, means for mechanically massaging the sorbent material into the oil and suction means for removing the sorbent material.

2. Apparatus as claimed in claim 1, wherein the sorbent material is supplied from a sorbent source and combined with air from a compressor.

3. Apparatus as claimed in claim 1, wherein a nozzle is provided for supplying the sorbent material to the massaging means.

4. Apparatus as claimed in claim 1, wherein the massaging means are arranged to spread the sorbent material prior to massaging it into the oil.

5. Apparatus as claimed in claim 1, wherein the massaging means comprises a plurality of mechanically rotating massaging members, such as brushes.

6. Apparatus as claimed in claim 5, wherein the massaging members are arranged such that rotation thereof in a first direction can cause the sorbent material to move outwardly from the centre of the device, and rotation thereof in a second direction, which is opposite to the first direction, can cause the sorbent material to move inwardly towards the centre of the device.

7. Apparatus as claimed in claim 5, wherein the massaging means is arranged to assist in recovering the sorbent material by reversing the direction of rotation of the massaging members.

8. Apparatus as claimed in claim 1, wherein the massaging means are elongate and arranged on a rotatable disc along lines extending from the periphery to the centre thereof

9. Apparatus as claimed in claim 8, wherein the lines along which the massaging means extend are curved.

10. Apparatus as claimed in claim 1, wherein the massaging means comprises a pair of co-axial rotatable discs, each having a set of massaging members such that there are inner and outer arrays of elongate massaging members.

11. Apparatus as claimed in claim 10, wherein the rotatable discs are arranged to contra-rotate.

12. Apparatus as claimed in claim 1, further comprising a skirt surrounding the massaging means.

13. Apparatus as claimed in claim 1, in combination with and connected to a source of air pressure and suction and a source or sorbent material.

14. Apparatus as claimed in claim 13, wherein the source of sorbent material is a source of bark.

15. A method of removing a liquid from a surface comprising conveying sorbent material to the surface entrained in a gas, mechanically massaging the sorbent material into the liquid and removing the sorbent material, wherein the steps of the method are all performed using a single device.

16. A method as claimed in claim 15, wherein the single device is an apparatus as claimed in claim 1.

17. A method as claimed in claim 15, wherein the fluid is oil or an oily substance.

18. A method as claimed in claim 15, wherein the liquid is petroleum.
